(19) United States
(12) Patent Application Publication
(10) Pub. No.: US 2015/0290979 A1
(43) Pub. Date: Oct. 15, 2015

(54) Tire Featuring Curved Bars

(71) Applicant: Bridgestone Americas Tire Operations, LLC, Nashville, TN (US)

(72) Inventors: Kevin J. Kosmac, Fairlawn, OH (US); Dennis W. Snyder, Uniontown, OH (US); Andrew T. Miklic, Akron, OH (US); Richard S. Parr, Canton, OH (US); Edward L. Smeltzer, Ashland, OH (US)

(21) Appl. No.: 14/641,329

(22) Filed: Mar. 7, 2015

Related U.S. Application Data
(60) Provisional application No. 61/978,970, filed on Apr. 13, 2014.

(51) Int. Cl. B60C 11/11

(52) U.S. Cl. CPC B60C 11/11; B60C 2011/0337

(57) ABSTRACT

Various embodiments of a tire featuring curved bars are disclosed.

### CROSS-REFERENCE TO RELATED APPLICATIONS

This application claims priority from U.S. Provisional Patent Application No. 61/978,970, filed on Apr. 13, 2014, which is incorporated by reference herein in its entirety.

### BACKGROUND

Many tires, including agricultural tires, include a tread portion. The tread portion may include positive tread elements such as bars, separated by an inner tread surface. Bars may fulfill a variety of purposes, including providing traction to the tire and supporting the tire on running surfaces.

Tires mounted on a rim include an aspect ratio. The aspect ratio is the percentage of the tire's section height, to the tire's section width. In some applications, it may be desirable to increase a tire's aspect ratio by increasing a tire's section height, without excessively increasing the tire's section width. As a result, it may be necessary to reduce the tread arc width of the tire (that is, the width of the tire's tread portion along an arc formed by the tread). However, reduction of a tire's tread arc width inherently minimizes the tire's ground contact area.

Additionally, in some applications, it may be desirable to minimize the amount of bars in a tire, without allowing the inner tread surface to extend radially outwardly and contact the running surface during operation of the tire. Such contact between the inner tread surface and the running surface may be referred to as bar punch. Bar punch may lead to excessive wear and durability concerns of the inner tread surface, which may necessitate premature replacement of the tire.

What is needed is a tire bar capable of increasing a tire's ground contact area and preventing or mitigating bar punch, without the necessity of adding additional bars.

### SUMMARY

In one embodiment, an irrigation tire including curved bars is provided, the irrigation tire comprising: a tire tread divided along a tire centerline into a first side and a second side, the tire tread including: a plurality of curved bars generally oriented on the first side of the tire tread and curved in a first direction; and a plurality of curved bars generally oriented on the second side of the tire tread and curved in a second direction; wherein each of the curved bars includes a lateral bar edge oriented near a shoulder portion of the tire tread and a bar nose oriented near a centerline of the tire tread; wherein each of the curved bars includes a first circumferential width at or near the tire centerline and a second circumferential width at or near the shoulder portion; and wherein the first circumferential width is less than the second circumferential width.

In another embodiment, a tire including curved bars is provided, the tire comprising: a tire tread divided along a tire centerline into a first side and a second side, the tire tread including: a plurality of curved bars generally oriented on the first side of the tire tread and curved in a first direction; and a plurality of curved bars generally oriented on the second side of the tire tread and curved in a second direction; wherein the first direction is opposite the second direction; wherein each of the curved bars comprises an outer radius oriented on a convex edge; wherein each of the curved bars comprises at least one inner radius oriented on a concave edge; and wherein the outer radius is greater than the inner radius.

### BRIEF DESCRIPTION OF THE DRAWINGS

The accompanying figures, which are incorporated in and constitute a part of the specification, illustrate various example configurations and are used merely to illustrate various example embodiments. In the figures, like elements bear like reference numerals.

FIG. 1 illustrates a perspective view of a tire tread 102 featuring curved bars 104A and 104B.

FIG. 2 illustrates a top elevational view of tire tread 102 featuring curved bars 104A and 104B.

FIG. 3 illustrates a cross-sectional view of tire tread 102 featuring curved bars 104A and 104B.

FIG. 4 illustrates a top elevational view of curved bar 104B.

### DETAILED DESCRIPTION

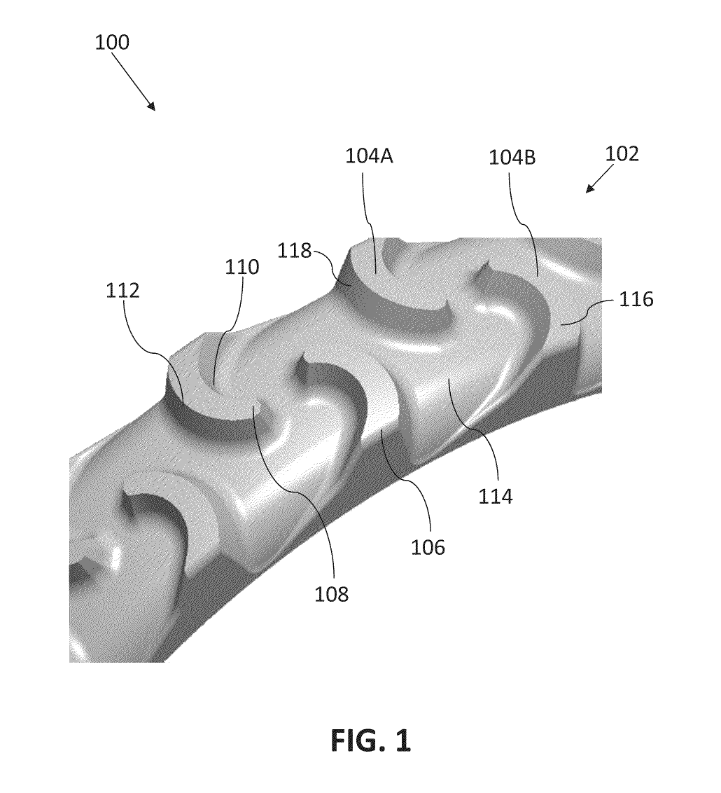

FIG. 1 illustrates a perspective view of a portion of tire 100 having a tire tread 102. Tire tread 102 may include at least curved bar 104A and at least one curved bar 104B. Curved bars 104A, 104B may have a lateral bar edge 106 and a bar nose 108. Curved bars 104A, 104B may include a concave edge 110. Curved bars 104A, 104B may include a convex edge 112. Curved bars 104A, 104B may be separated by an inner tread surface 114. Curved bars 104A, 104B may include a road contacting surface 116. Curved bars 104A, 104B may additionally include a bar surface 118.

Curved bars 104A, 104B may be configured to provide traction to tire 100. Tire 100 may be used in agricultural applications. Tire 100 may an irrigation tire. Tire tread 102 featuring curved bars 104A, 104B may be non-directional. Tire tread 102 featuring curved bars 104A, 104B may be directional. Tire 100 featuring tire tread 102 may be a radial tire. Alternatively, tire 100 may be a bias tire.

Tire tread 102 may be generally divided along its centerline, wherein a plurality of curved bars 104A may be generally oriented on a first side of tire tread 102. A plurality of curved bars 104B may be generally oriented on a second side of tire tread 102. Curved bars 104A may be generally curved in a first direction. Curved bars 104B may be generally curved in a second direction. The first direction may be opposite the second direction. The first direction may be about 180 degrees relative to the second direction, taken along a plane oriented with one axis extending in the axial direction, and another axis extending in the circumferential direction. In one embodiment, at least two of a plurality of curved bars 104A may be generally curved in more than one direction. In one embodiment, at least two of a plurality of curved bars 104B may be generally curved in more than one direction. Curved bars 104A, 104B may overlap one another and extend across the centerline. In such a scenario, the term “generally oriented” on a first side or second side is intended to indicate that the majority of curved bars 104A, 104B are oriented on one side of the centerline or the other.

Curved bars 104A, 104B may be curved in any of a variety of directions, such that concave edge 110 faces in at least one of a generally circumferential direction, a generally axial direction, and a direction between a generally circumferential direction and a generally axial direction.

Lateral bar edge 106 may be oriented in shoulder region of tire tread 102. Lateral bar edge 106 may be oriented in an axially-outer direction, away from a centerline of tire tread 102.

Bar nose 108 may be oriented near the centerline of tire tread 102. Bar nose 108 may extend past the centerline of tire tread 102, such that curved bars 104A, 104B each extend from a shoulder region, and past the centerline. Bar nose 108 may extend to the centerline of tire tread 102. Bar nose 108 may terminate without extending past, or to, the centerline of the tire tread 102.

Concave edge 110 may be oriented on a first side of curved bars 104A, 104B, while convex edge 112 may be oriented on a second side of curved bars 104A, 104B. In such a manner, curved bars 104A, 104B may form a bar having a curve, similar to a “U.” Concave edge 110 may include at least one radius. Concave edge 110 may include multiple radii. Convex edge 112 may include at least one radius. Convex edge 112 may include multiple radii.

Inner tread surface 114 may be oriented between curved bars 104A, 104B. Stated differently, curved bars 104A, 104B may be separated by inner tread surface 114. Inner tread surface 114 may be configured to not contact a running surface. Inner tread surface 114 may be configured to contact a soft running surface, such as mud or soft soil, while being configured to not contact a hard running surface, such as asphalt.

Road contacting surface 116 may be configured to contact a running surface. Road contacting surface 116 may be configured to support the tire on a hard running surface. Road contacting surface 116 may be the radially outer portion of curved bars 104A, 104B.

Bar surface 118 may surround curved bars 104A, 104B. Bar surface 118 may extend between road contacting surface 116 and inner tread surface 114. Bar surface 118 may be oriented substantially radially. Bar surface 118 may be angled, such that curved bars 104A, 104B decrease in at least one of width and length as curved bars 104A, 104B extend radially outwardly from the level of inner tread surface 114.

Tire 100 may have an aspect ratio of about 120. Tire 100 may have an aspect ratio between about 50 and about 150. Tire 100 may have an aspect ratio between about 70 and about 90. Tire 100 may have an aspect ratio between about 100 and about 120. Tire 100 may have any of a variety of aspect ratios, including aspect ratios within any of the ranges provided herein. Tire 100 may have a range of aspect ratios utilizing any of the upper and lower limits provided herein.

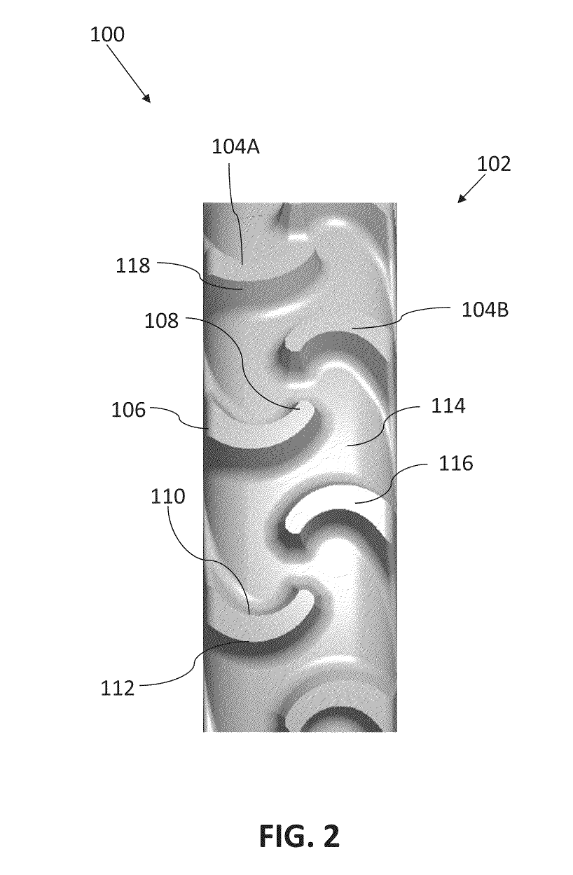

FIG. 2 illustrates a top elevated view of a portion of tire 100 having a tire tread 102. As illustrated, in one embodiment bar nose 108 may extend past the centerline of tire tread 102. As a result, curved bars 104A, 104B may overlap one another. Curved bars 104A, 104B may overlap one another by a distance that is between about 1% and about 10% of the overall tread arc width of tire tread 102.

In one embodiment, the overall width (measured circumferentially) of each of curved bars 104A, 104B may be greater than prior art tires. Curved bars 104A, 104B may be provided with a width, a number, and a density configured to substantially prevent, or reduce, bar punch conditions. That is, curved bars 104A, 104B may be provided so as to prevent too large an area between curved bars 104A, 104B, wherein inner tread surface 114 can extend radially outwardly and contact a running surface. The curved nature of curved bars 104A, 104B may contribute to the to the increased overall width of curved bars 104A, 104B. The overall width of curved bars 104A, 104B is defined as the width of curved bars 104A, 104B measured in the circumferential direction from one circumferential extreme of a single curved bar 104A, 104B to another circumferential extreme of that curved bar 104A, 104B. The curved nature of curved bars 104A, 104B may contribute to the prevention of too large an area between curved bars 104A, 104B, and thus contribute to the prevention or reduction of bar punch conditions.

Tire tread 102 may include a bar density between about 10% and about 50%. Tire tread 102 may include a bar density between about 20% and about 40%. Tire tread 102 may include a bar density between about 25% and about 35%. Tire tread 102 may include a bar density of about 30%. Bar density is defined as the sum of the volume of all curved bars 104A, 104B, divided by total bar and void volume of tire tread 102, and multiplied by 100. Tire tread 102 may have any of a variety of bar densities within any of the ranges provided herein. Tire tread 102 may have a range of bar densities utilizing any of the upper and lower limits provided herein.

Tire tread 102 may include a bar pitch between about 1% and about 10%. Tire tread 102 may include a bar pitch between about 2% and about 8%. Tire tread 102 may include a bar pitch between about 3.5% and about 6.5%. Tire tread 102 may include a bar pitch of about 5%. Bar pitch is defined as 1 divided by the number of bars on a single side of tire tread 102 (e.g., number of curved bars 104A), and multiplied by 100. In one exemplary embodiment, tire tread 102 includes 19 curved bars 104A and 19 curved bars 104B.

The curved nature of curved bars 104A, 104B may contribute to improved traction in tire 100, as a result of an increased amount of bar edges presented to a running surface.

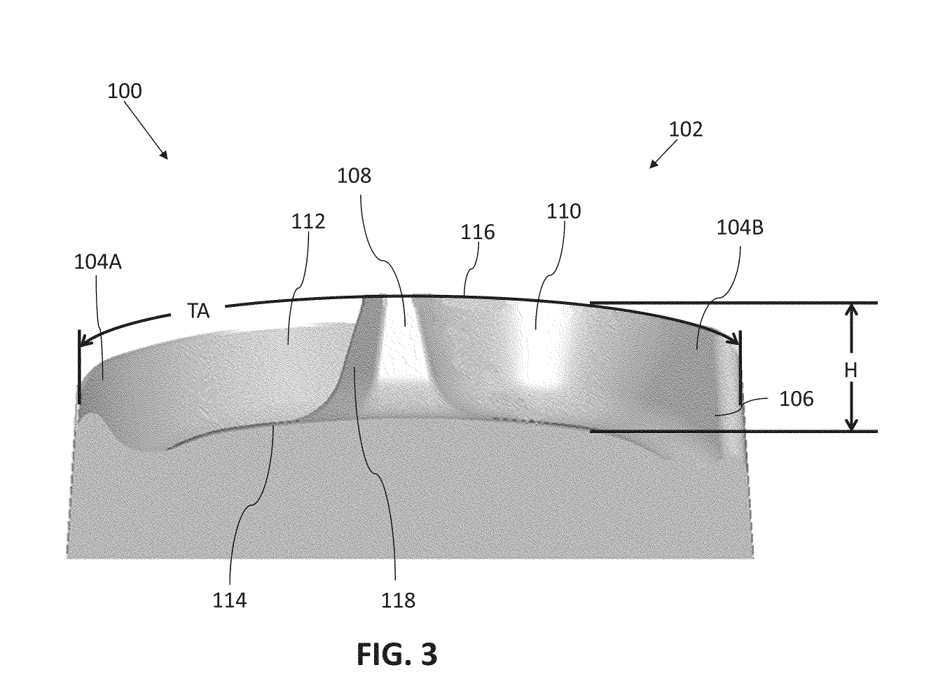

FIG. 3 illustrates a cross-sectional view of tire 100 having a tire tread 102. As is more clearly illustrated in FIG. 3, curved bars 104A, 104B may include angled and/or sloped bar surfaces 118. Angled and/or sloped bar surfaces 118 may provide greater support and stability of curved bars 104A, 104B. Angled and/or sloped bar surfaces 118 may provide increased stiffness of curved bars 104A, 104B relative to inner tread surface 114. Angled and/or sloped bar surfaces 118 may mitigate formation and/or propagation of cracks at the base of curved bars 104A, 104B.

Each of curved bars 104A, 104B may include a height H (measured radially). Height H may vary depending upon intended application of tire 100. Height H may be between about 10 mm and about 65 mm. Height H may be between about 20 mm and about 55 mm. Height H may be between about 30 mm and about 45 mm. Height H may be about 36 mm. Curved bars 104A, 104B may have any of a variety of heights H, including heights H within any of the ranges provided herein. Curved bars 104A, 104B may have a range of heights H utilizing any of the upper and lower limits provided herein.

Tire tread 102 may have a tread arc width TA. Tread arc width TA may vary depending upon intended application of tire 100. Tread arc width TA may vary depending upon desired aspect ratio of tire 100. Tread arc width TA may vary depending upon desired section width of tire 100.

Tread arc width TA may be between about 75 mm and about 380 mm. Tread arc width TA may be between about 150 mm and about 330 mm. Tread arc width TA may be between about 150 mm and about 250 mm. Tread arc width TA may be about 200 mm. Tire tread 102 may have any of a variety of tread arc widths TA, including tread arc widths TA within any of the ranges provided herein. Tire tread 102 may have a range of tread arc widths TA utilizing any of the upper and lower limits provided herein.

As discussed above, each of curved bars 104A, 104B may overlap one another near the centerline of tire tread 102. The amount of overlap may vary depending upon intended application of tire 100. The overlapped distance of each of curved bars 104A, 104B may be between about 1% and about 20% of tread arc width TA. The overlapped distance may be between about 4% and about 15% of tread arc width TA. The overlapped distance may be between about 5% and about 10% of tread arc width TA. The overlapped distance may be about 7% of tread arc width TA. Tire tread 102 may have any of a variety of overlapped distances, including overlapped distances within any of the ranges provided herein. Tire tread 102 may have a range of overlapped distances utilizing any of the upper and lower limits provided herein.

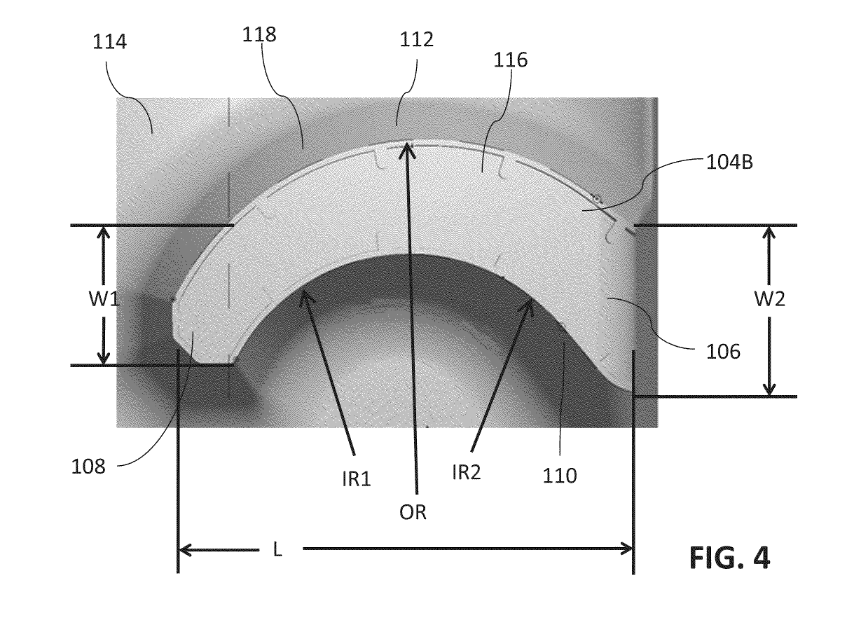

FIG. 4 illustrates a top elevational view of curved bar 104B. Curved bar 104B may include at least one outer radius OR, and at least one inner radius, including for example IR1 and IR2. Curved bar 104B may include a length L (measured axially). Curved bar 104B may include a first circumferential width W1 (measured circumferentially) at or near the centerline of tire tread 102, and a second circumferential width W2 (measured circumferentially) at or near a shoulder region of tire tread 102.

Outer radius OR may vary depending upon intended application of tire 100. Outer radius OR may vary depending upon at least one of size, bar density, load demands, target inflation pressure, and the like of tire 100. Outer radius OR may be between about 30% and about 105% of length L. Outer radius OR may be between about 34.4% and about 102.3%. Outer radius OR may be between about 40% and about 80% of length L. Outer radius OR may be between about 50% and about 70% of length L. Outer radius OR may be about 61% of length L. Curved bar 104B may have any of a variety of outer radii OR, including outer radii OR within any of the ranges provided herein. Curved bar 104B may have a range of outer radii OR utilizing any of the upper and lower limits provided herein.

Inner radii IR1 and IR2 may be equal. Alternatively, inner radius IR1 may be less than inner radius IR2. Alternatively, inner radius IR1 may be greater than inner radius IR2.

Inner radii IR1 and IR2 may vary depending upon intended application of tire 100. Inner radii IR1 and IR2 may vary depending upon at least one of size, bar density, load demands, target inflation pressure, and the like of tire 100. Inner radius IR1 may be oriented nearer bar nose 108. Inner radius IR2 may be oriented nearer lateral bar edge 106.

Inner radius IR1 may be between about 10% and about 70% of length L. Inner radius IR1 may be between about 20% and about 60% of length L. Inner radius IR1 may be between about 30% and about 50% of length L. Inner radius IR1 may be about 42% of length L. Inner radius IR1 may be between about 50% and about 90% of outer radius OR. Inner radius IR1 may be between about 60% and about 80% of outer radius OR. Inner radius IR1 may be between about 65% and about 75% of outer radius OR. Inner radius IR1 may be about 69% of outer radius OR. Curved bar 104B may have any of a variety of inner radii IR1, including inner radii IR1 within any of the ranges provided herein. Curved bar 104B may have a range of inner radii IR1 utilizing any of the upper and lower limits provided herein.

Inner radius IR2 may be between about 30% and about 90% of length L. Inner radius IR2 may be between about 40% and about 80% of length L. Inner radius IR2 may be between about 50% and about 70% of length L. Inner radius IR2 may be about 57% of length L. Inner radius IR2 may be between about 80% and about 98% of outer radius OR. Inner radius IR2 may be between about 85% and about 96% of outer radius OR. Inner radius IR2 may be between about 90% and about 95% of outer radius OR. Inner radius IR2 may be about 93% of outer radius OR. Curved bar 104B may have any of a variety of inner radii IR2, including inner radii IR2 within any of the ranges provided herein. Curved bar 104B may have a range of inner radii IR2 utilizing any of the upper and lower limits provided herein.

In one embodiment, inner radius IR1 is substantially equal to inner radius IR2, in which case inner radii IR1 and IR2 may simply be referred to as an inner radius.

Length L may vary depending upon intended application of tire 100. Length L may vary depending upon at least one of size, bar density, load demands, target inflation pressure, and the like of tire 100. Length L may be between about 30% and about 90% of tread arc width TA. Length L may be between about 40% and about 80% of tread arc width TA. Length L may be between about 50% and about 70% of tread arc width TA. Length L may be about 57% of tread arc width TA. Curved bar 104B may have any of a variety of lengths L, including lengths L within any of the ranges provided herein. Curved bar 104B may have a range of lengths L utilizing any of the upper and lower limits provided herein.

Curved bar 104B may include a width W1 (measured circumferentially) at or near the centerline of tire tread 102, and a width W2 (measured circumferentially) at or near a shoulder region of tire tread 102. In one embodiment, width W1 is equal to width W2. Alternatively, width W1 may be less than width W2. Alternatively, width W1 may be greater than width W2.

Width W2 may vary depending upon intended application of tire 100. Width W2 may vary depending upon at least one of size, bar density, load demands, target inflation pressure, and the like of tire 100. Width W2 may be between about 20% and about 50% of length L. Width W2 may be between about 25% and about 45% of length L. Width W2 may be between about 30% and about 40% of length L. Width W2 may be about 35% of length L. Curved bar 104B may have any of a variety of widths W2, including widths W2 within any of the ranges provided herein. Curved bar 104B may have a range of widths W2 utilizing any of the upper and lower limits provided herein.

Width W1 may vary depending upon intended application of tire 100. Width W1 may vary depending upon at least one of size, bar density, load demands, target inflation pressure, and the like of tire 100. Width W1 may be between about 15% and about 45% of length L. Width W1 may be between about 20% and about 40% of length L. Width W1 may be between about 25% and about 35% of length L. Width W1 may be about 30% of length L. Width W1 may be about 31% of length L. Width W1 may be between about 76% and about 96% of width W2. Width W1 may be between about 81% and about 91% of width W2. Width W1 may be about 86% of width W2. Curved bar 104B may have any of a variety of widths W1, including widths W1 within any of the ranges provided herein. Curved bar 104B may have a range of widths W1 utilizing any of the upper and lower limits provided herein.

Curved bar 104B may have a width W2 that is greater than width W1 to provide greater bar area in the shoulder portion of tire tread 102 near lateral bar edge 106. In one embodiment, tire 100 may experience a camber during use. Increased bar area in the shoulder portion of tire tread 102 may improve performance of tire 100 in a high camber application. Cambers experienced during use may range between about 0 degrees and 10 degrees in either direction (positive or negative). In one embodiment, cambers experienced during used may range between about 0 degrees and about 6 degrees. That is, tire 100 may be subjected to camber values of 1 degree, 2 degrees, 3 degrees, 4 degrees, 5 degrees, and/or 6 degrees.

While various dimensions and values have been provided herein with respect to curved bar 104B, it is contemplated that curved bar 104A can have the same or similar dimensions and values. In one embodiment, curved bar 104A may include the same dimensions and values as curved bar 104B in a given tire tread 102. Alternatively, curved bar 104A may include different dimensions and values as compared to curved bar 104B in a given tire tread 102.

In one example embodiment, tire 100 is an irrigation tire for application on an irrigation system. Tire 100 is non-directional, and may be configured to travel in either rotational direction. Tire 100 may have an outside diameter of about 1,270 mm. Tire 100 may have an outside diameter of about 1,282 mm. Tire 100 may have an outside diameter of about 1,295 mm. Tire 100 may have a section width of about 285 mm. Tire 100 may have a section width of about 282 mm. Tire 100 may have a section width of about 213 mm. Tire 100 may have an aspect ratio of about 120. Tire 100 may have an inflation pressure of about 138 kPa. Tire 100 may be configured to support a load of about 22.6 kN. Tire 100 may be configured for application to a 11.2-24 rim. Tire 100 may include curved bars 104A, 104B having a height H of about 36 mm. Curved bars 104A, 104B may be configured to eliminate bar punch. Tire 100 may be configured to operate with a camber up to about 6 degrees. Tire 100 may be of a radial construction.

In one example embodiment, tire 100 is configured for application to a rim measuring about 203 mm in width, and about 610 mm in diameter. In another example embodiment, tire 100 is configured for application to a rim measuring about 254 mm in width, and about 609 mm in diameter.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. An irrigation tire including curved bars, comprising:
a tire tread divided along a tire centerline into a first side and a second side, the tire tread including:
a plurality of curved bars generally oriented on the first side of the tire tread and curved in a first direction; and
a plurality of curved bars generally oriented on the second side of the tire tread and curved in a second direction;
wherein each of the curved bars includes a lateral bar edge oriented near a shoulder portion of the tire tread and a bar nose oriented near a centerline of the tire tread;
wherein each of the curved bars includes a first circumferential width at or near the tire centerline and a second circumferential width at or near the shoulder portion; and
wherein the first circumferential width is less than the second circumferential width.

2. The irrigation tire of claim 1, wherein each of the curved bars comprises a concave edge and a convex edge.

3. The irrigation tire of claim 1, wherein the first direction is opposite the second direction.

4. The irrigation tire of claim 1, wherein each of the curved bars comprises an outer radius oriented on a convex edge; and wherein each of the curved bars comprises at least one inner radius oriented on a concave edge.

5. The irrigation tire of claim 4, wherein the at least one inner radius is between about 50% and about 90% of the outer radius.

6. The irrigation tire of claim 4, wherein each of the curved bars comprises a length; wherein the at least one inner radius is between about 10% and about 70% of the length; and wherein the outer radius is between about 30% and about 90% of the length.

7. The irrigation tire of claim 1, wherein the curved bars generally oriented on the first side of the tire tread axially overlap the curved bars generally oriented on the second side of the tire tread.

8. The irrigation tire of claim 1, wherein each of the curved bars comprises a length, and wherein the first circumferential width is between about 15% and about 45% of the length.

9. The irrigation tire of claim 1, wherein each of the curved bars comprises a length, and wherein the second circumferential width is between about 20% and about 50% of the length.

10. The irrigation tire of claim 1, wherein the first circumferential width is between about 76% and about 96% of the second circumferential width.

11. A tire including curved bars, comprising:
a tire tread divided along a tire centerline into a first side and a second side, the tire tread including:
a plurality of curved bars generally oriented on the first side of the tire tread and curved in a first direction; and
a plurality of curved bars generally oriented on the second side of the tire tread and curved in a second direction;
wherein the first direction is opposite the second direction;
wherein each of the curved bars comprises an outer radius oriented on a convex edge;
wherein each of the curved bars comprises at least one inner radius oriented on a concave edge; and
wherein the outer radius is greater than the inner radius.

12. The tire of claim 11, wherein the at least one inner radius is between about 50% and about 90% of the outer radius.

13. The tire of claim 11, wherein each of the curved bars comprises a length and wherein the at least one inner radius is between about 10% and about 70% of the length.

14. The tire of claim 11, wherein each of the curved bars comprises a length and wherein the outer radius is between about 30% and about 90% of the length.

15. The tire of claim 11, wherein the curved bars generally oriented on the first side of the tire tread axially overlap the curved bars generally oriented on the second side of the tire tread.

16. The tire of claim 11, wherein:
each of the curved bars includes a lateral bar edge oriented near a shoulder portion of the tire tread and a bar nose oriented near a centerline of the tire tread;
wherein each of the curved bars includes a first circumferential width at or near the tire centerline and a second circumferential width at or near the shoulder portion; and
wherein the first circumferential width is less than the second circumferential width.

17. The tire of claim 16, wherein each of the curved bars comprises a length, and wherein the first circumferential width is between about 15% and about 45% of the length.

18. The tire of claim 16, wherein each of the curved bars comprises a length, and wherein the second circumferential width is between about 20% and about 50% of the length.

19. The tire of claim 16, wherein the first circumferential width is between about 76% and about 96% of the second circumferential width.
